(19) United States
(12) Patent Application Publication
(10) Pub. No.: US 2004/0212259 A1
(43) Pub. Date: Oct. 28, 2004

(54) Wheel motor

(76) Inventor: Len Charles Gould, Brampton (CA)

Correspondence Address: Mr. Len C. Gould, 43 Copeland Road, Brampton, ON, L6Y 2S5, CA

(21) Appl. No.: 10/421,821

(22) Filed: Apr. 24, 2003

(51) Int. Cl. H02K 7/00; H02K 11/00

(52) U.S. Cl. 310/67 R; 310/257

(57) ABSTRACT

This invention is a new dynamo electric machine of the synchronous alternating current type designed to be installed as the wheel of a motor vehicle. Disclosed are three primary embodiments which together or in combination can be applied to the purpose. Also disclosed is a means of ensuring coordinated operation of several of the machines installed onto the same motor vehicle while maintaining a simple central control system.

### RELATED APPLICATIONS

NA

### STATEMENT REGARDING FEDERALLY SPONSORED RESEARCH OR DEVELOPMENT

Not applicable

U.S. Patent Documents

| | | | |
|---|---|---|---|
| 5,901,801 | May 11, 1999 | Toida et al. | 180/65.1 |
| 5,633,544 | May 27, 1997 | Toida et al. | 310/67R |
| 5,782,716 | Jul. 21, 1998 | Hukui et al. | 475/149 |
| 6,118,196 | Sep. 12, 2000 | Cheng-Yon | 310/75C |
| 6,495,941 | Dec. 17, 2002 | Nishimura | 310/68 |
| 6,199,651 | Mar. 13, 2001 | Guy | 180/220 |
| 6,199,652 | Mar. 13, 2001 | Mastroianni | 180/229 |
| 6,355,996 | Mar. 12, 2002 | Birkestrand | 310/54 |
| 6,540,632 | Apr. 1, 2003 | Wendl et al. | 180/65.5 |
| 6,367,571 | Apr. 9, 2002 | Schwarz | 180/253 |
| 6,328,123 | Dec. 11, 2001 | Niemann | 180/65.5 |

### FIELD OF THE INVENTION

This invention applies to dynamo electric machines employed to drive or be driven by the wheel of a motor vehicle.

### BACKGROUND OF THE INVENTION

It is known to employ an electric motor built into a wheel of a vehicle to provide traction force to drive the vehicle. Toida et al. in U.S. Pat. Nos. 5,633,544 and 5,901,801describe installing a brushless permanent magnet electric motor of standard construction, that is with rotor rotatably mounted within the stator, and a double reduction gear mechanism within the wheel of a motor vehicle for the purpose of providing motive or braking force.

Wendl et at in U.S. Pat. No. 6,540,632 do get almost all the required parts, those being a disk brake and caliper, a motor, provision for steering pivots and linkage, and provision for suspension, fitted approximately into the wheel hub space, but their inclusion still of a gear reducer, though of excellent design, still causes the package to protrude a larger than ideal distance toward the center of the vehicle, and they do not contemplate using it on a steerable wheel.

Niemann et al. in U.S. Pat. No. 6,328,123 describe installing an inverted induction motor within a wheel hub of a dual wheel bus, having the induction rotor constructed external to the stator. However the characteristics of the induction motor in this form leave them still using half the width available within the wheel for brake caliper. Noteable also is that the capability of an induction motor in this form to act as a regenerative braking generator would be questionable or complex to implement. They mention possibly using permanent magnets to replace the induction magnet poles in the rotor but do not persue regenerative braking further. Also though compact width is their stated goal, they do not consider moving the brake caliper into the plane of the motor. Their design presented incorporates a gearbox occupying the hollow center ot their motor resulting in a very complex, fairly heavy and likely expensive installation. There is also no explicit provision made for cooling of the rotor iron, which can develop considerable heat in a high frequency motor, although to be fair they are not likely contemplating high speeds since the design is stated as being targeted toward transit type buses.

Several others including Birkestrand in U.S. Pat. No. 6,355,996, Guy in U.S. Pat. No. 6,199,651, Hukui in U.S. Pat. No. 5,782,716, Schwartz in U.S. Pat. No. 6,367,571 etc. describe installing various electric motors along with gear mechanisms within the wheel(s) of motor vehicles for purposes of direct propulsion and sometimes also dynamic braking, however none have yet fitted the package into a perfect space or size from the point of view of an automobile designer.

It is also known to employ adaptations of the claw pole dynamo electric machine as a motor and or generator when built into the hub of a wheel of a vehicle.

Cheng-Yon in U.S. Pat. No. 6,118,196 teaches the construction of a permanent magnet claw pole machine which generates alternating current in a fixed bobbin wound coil surrounded by a claw pole stator excited by permanent magnets mounted externally on a surrounding rotatable wheel hub.

The industry still requires a system which can, particularly in standard automotive applications, incorporate within the wheel hub of a vehicle an electric drive system capable of meeting all of the following requirements:

a) Provide continuous power to the driven wheel of at least 7.5 Kw, ideally more.

b) Allow a typical standard automotive mechanical braking disk and caliper to be installed in fairly normal fashion onto the wheel.

c) Operate efficiently and with a fairly flat torque curve from 0 to at least 1200 rpm.

d) Produce at stall speed at least 1000 NM torque. (based on direct drive, 4 motors starting a 3000 kg vehicle including load on a 30 degree incline.)

e) Allow reasonable provision for a vertical pivot and linkage to effect steerability of the driven wheel.

f) Allow reasonable provision for a horizontal pivot and linkage system for suspension.

g) Make minimal projection to the inner side of the wheel for reasons of interior space.

h) Make minimal projection to the outer side of the wheel for reasons of vehicle width and stability.

i) Operate properly with only a continuous DC power supply and a digital rate demand signal.

j) Automatically implement regenerative braking based on the digital rate demand signal, with the regenerated power provided back to the DC power supply at sufficiently higher voltage to achieve charging of a supply battery.

j) Add minimum mass to the unsprung weight of the wheel hub assembly.

k) Allow a quick exchange of tire and rim assembly when necessary.

l) Be rugged anough to withstand a full range of environmental conditions for the life of the vehicle.

m) Contribute positively to the vehicle asthetic design.

None of the current art motor vehicle wheel motor system as yet meet even a majority of these requirements, a situation which this patent is designed to alleviate.

### SUMMARY OF THE INVENTION

It is an object of the present invention to provide a novel design of motor for installation into the drive wheels of an automotive type vehicle, ideally satisfying the list of requirements presented in the previous section.

This objective is achieved by selecting, for a particular vehicle application, one or a combination of three different synchronous electric wheel motor designs embodying the present invention as follows.

The first embodiment is a dynamo electric machine constructed in the lundel or claw pole fashion but, rather than having the extended pole pieces or claws and DC winding of the exciter rotating on a shaft at the centre of a fixed wound stator, the exciter and its DC winding is installed in a fixed position mechanically mounted to the back of the stator but magnetically isolated from the stator, with these extended claws directly interleaved between the teeth of the stator. A standard 3 phase AC motor winding is then wound onto the teeth of the stator. Both the exciter body and the stator are mounted in a fixed position within the wheel with both the extended exciter claw faces and the stator teeth projecting radially outward to make magnetic contact with the faces of pole pieces embedded within the outer rim of a wheel which acts as the rotor and is fabricated structurally from a non-magnetic material such an aluminum alloy or anealed stainless steel. In this embodiment the number of pole pieces is equal to [stator tooth count]×[stator tooth count+1]/[stator tooth count]. The exciter body and extended claws are constructed of a simple solid magnetic material such as iron, but the stator and the pole pieces, being oppositely magnetized on each half electrical cycle, should be fabricated from a laminated magnetic material to reduce eddy currents.

The entire stator, including the exciter, is then hermetically enclosed within a non-magnetic casing which includes a thin stiff sheet of non-magnetic annealed stainless steel bonded to the faces of the teeth and the claws between the faces and the outer wheel rim. Provision is made for cooling of the stator assembly either by providing sufficient cooling air to be propelled by the movement of the wheel during travel, or ducting forced cooling air or fluid from a central location on the vehicle to each wheel. Because of the electrical design of this stator and rotor assembly, it can be entirely electrically balanced while not completely encompassing 360 degrees of arc within the wheel, so a gap may be left in the stator structure to provide space for mounting of the caliper assembly of a standard disk brake. Also while constructing the enclosure, an enclosed space may be provided within the assembly for mounting of an electronics package which may include i) a transistor or IGBT variable speed drive and ii) the digital control package for the variable speed drive and iii) an exciter power management transistor and control and iv) a bidirectional signal package which can recieve rate commands from a central control unit as well as from other wheels on the vehicle for directional travel and dynamic braking force management, and transmit rate data and diagnostic data to other interested listeners on the signal circuit. The sensing of actual rate of the local wheel may be developed by one or more of a sensor circuit on the motor windings which can resolve power frequency and pole slips, or a sensor such as a hall effect sensor directly sensing pole pieces in the rim or a current standard small toothed wheel and sensor system such as is used for ABS automatic braking management in current vehicles.

This motor assembly meets all of the stated requirements provided sufficient power can be designed into the width and diameter of the wheel contemplated, and the operating frequency does not cause the pole material to develop high temperatures. If the power requirement causes the width of the motor assembly to interfere mechanically or aesthetically with the vehicle being designed, then consideration should be given to one of the following embodiments.

If a particular design criteria requires it, the body of the exciter may be replaced with a ring of permanent magnetic material allowing the exciter coil to be eliminated, reduced in size, or connected in reverse polarity to buck the permanent magnetic field when DC power is applied to it. If permanent magnet excitation is considered, however, care should be given to its effect on the motor's dynamic braking and free wheeling capabilities if those are important to the design.

It can be seen that this motor design achieves the stated goals. It eliminates the gear mechanism commonly installed between the motor and the wheel hub to multiply the torque of the electric motor, typically by a factor of 5:1 with a 90% efficiency. This is accomplished by extending the length of the torque arm of the motor active parts by a factor of approximately 2.5, then replacing part of the mass of the now unnecessary motor frame and its bearings and the gear system and its complex bearing and lubrication systems with additional stator poles and windings in a factor of approximately 2:1. This results in a wheel motor having equal starting torque but double the current requirement at breakaway. However, the time frame of this increased current requirement is only for the very short periods of peak torque requirement, which has little effect on overall performance efficiency. For times of normal operation, due to the unique design of this motor, the added windings can be simply electronically eliminated from the circuit if necessary with no ill effect on the electrical or mechanical balance of the motor, or they may be left in circuit at greatly reduced current, reducing the thermal spot peaks within the windings at norml loads. The design also results in a machine with double the dynamic braking generator capability than the geared counterpart, and greater flexibility in how the braking energy may be generated. By selectively electronically exciting the stator only in selected segments according to braking demand, the regenerated power voltage can be more easily maintained high enough to be useable to feed back into a fixed voltage battery even at variable braking energy demands, which is a significant benefit of the design.

The second preferred embodiment of the present invention is a dynamo electric machine constructed in the lundel or claw pole fashion but, rather than having the extended pole pieces or claws and DC winding of the exciter rotating on a shaft at the centre of a fixed wound stator, the exciter and its DC winding is installed in a fixed position mechanically mounted to the back of the stator but magnetically isolated from the stator, with these extended claws replaced by two rings of magnetic material projecting at the sides but magnetically seaparated from the teeth of the stator. A standard 3 phase AC motor winding is then wound onto the teeth of the stator. Both the exciter body and the stator are mounted in a fixed position within the wheel with both the extended exciter ring faces and the stator teeth projecting outward to make magnetic contact with the faces of pole pieces embedded within the outer rim of a wheel which acts as the rotor and is fabricated structurally from a non-magnetic material such an aluminum alloy or anealed stainless steel. In this embodiment the number of pole pieces is equal to the number of teeth on the stator divided by the phase count of the dynamo machine, but the pole pieces on the wheel rim do not extend fully from one exciter ring to the other. Instead, alternate pole pieces along the circumference of the wheel rim project alternately toward one exciter ring at one side of the armature teeth, or to the other exciter ring at the other side of the armature teeth, in a manner which causes alternate circumferential pole pieces to become magnetic pole projections alternately of the north magnetic pole of the exciter, or of the south magnetic pole of the exciter. In this embodiment, these rotor pole pieces never change magnetic polarity so they need not be made of a laminated material, a simple solid casting will suffice. This also means that no provision for cooling of these pole pieces need be made, and the pole pieces could potentially contribute to the structural integrity of the rim assembly.

The balance of this second embodiment is identical to the first preferred embodiment.

An alternate configuration of the second preferred embodiment has multiple armatures constructed in the same manner and sharing the adjacent projecting rings of their individual exciters. The rotor pole pieces of this configuration now alternately make magnetic contact either at their centre with an exciter ring which is shared between the armatures, extending in a single piece across two adjacent armatures, or are separated in the area below the shared exciter ring and project to the further exciter ring to make magnetic contact with the appropriate exciter ring of opposite magnetic polarity. This configuration would be used if the width of the stator required to implement adequate power made the pole pieces unable to adequately conduct the magnetic lines of force accross the tooth faces of the entire armature in the space available. By splitting the armature body into two or more parts separated by exciter rings of opposite magnetic polarity, the width of armature tooth required to be excited by each pole piece is correspondingly reduced, at the expense of space efficiency and AC winding complexity. In this manner stators of arbitraty width could be fabricated.

The balance of this second embodiment configuration is identical to the first preferred embodiment.

The third preferred embodiment of the present invention is a dynamo electric machine constructed in the lundel or claw pole fashion but, rather than having the extended pole pieces or claws and DC winding of the exciter rotating on a shaft at the centre of a fixed wound stator, the exciter is created from pole pieces as projecting teeth interleaved in fixed position mechanically between the projecting teeth of the main AC stator core and projecting at the face. The exciter DC winding is then wound individually onto the assigned pole piece projecting teeth. A standard 3 phase AC motor winding is then wound onto the remaining teeth of the stator armature. The stator is mounted in a fixed position within the wheel with both the extended exciter teeth and the stator teeth projecting outward to make magnetic contact with the faces of pole pieces embedded within the outer rim of a wheel which acts as the rotor and is fabricated structurally from a non-magnetic material such an aluminum alloy or anealed stainless steel. In this embodiment the number of pole pieces is equal to [stator AC tooth count]×[stator AC tooth count+1]/[stator AC tooth count]. This design provides for a reduction in total magnetic material mass but an increase in DC winding length for an equivalent torque capability, and some reduction in power density on an angular arc or gap area basis for an equal tooth length.

The balance of this third embodiment is identical to the first preferred embodiment.

### DESCRIPTION OF THE DRAWINGS

In drawings which illustrate embodiments of the invention,

FIG. 1 is a perspective view of a first preferred embodiment of the present invention.

FIG. 2 is a section view along the axis of the dynamo electric machine of FIG. 1

FIG. 3 is a cross section view through the body of the dynamo electric machine of FIG. 1

FIG. 4 is a plan view of how the pole pieces of the wheel rim are formed.

FIG. 5 is a perspective view of a second preferred embodiment of the present invention.

FIG. 6 is a section view detail along the axis of FIG. 5.

FIG. 7 is a section view along the axis of an alternate implementation of the second preferred embodiment of the present invention having multiple armatures mounted on the same axis and sharing exciter parts.

FIG. 8 is a cross section view through the body of the dynamo electric machine of FIG. 6 or FIG. 7.

FIG. 9 is a cross section view through the body of the dynamo electric machine of FIG. 6 or FIG. 7 having less than 360 degrees of arc filled by stator, the gap being provided to mount a brake caliper.

FIG. 10 is a perspective view of a third preferred embodiment of the present invention.

FIG. 11 is a section view of FIG. 10.

FIG. 12 is a cross section view through the body of the dynamo electric machine of FIG. 11.

### DETAILED DESCRIPTION OF THE INVENTION

Throughout all the drawings showing the embodiments of the invention, corresponding elements and parts are designated by identical reference numerals.

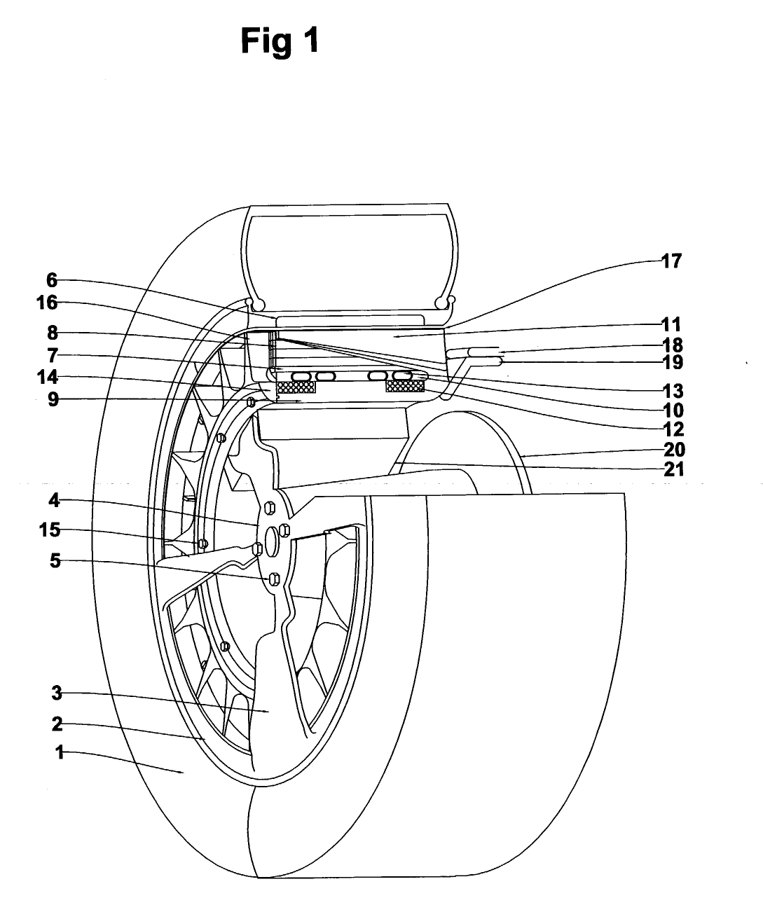

In FIG. 1 is a perspective view partly cut away of a first preferred embodiment of the present invention. Illustrated is a wheel assembly consisting of a wheel comprised of a tire 1, a rim 2, and spokes 3 mounted on a hub 4 with lugnuts 5, the hub mounted on an axle by bearings not shown. Embedded into the h the faces exposed inward are laminated magnetic pole pieces 6, the pieces separated from each other by a narrow strip of nonmagnetic material such as annealed stainless steel or aluminum alloy. A laminated magnetic core armature is then formed having a complete ring at the inner edge 7 with teeth projecting outward radially to approach very near the pole pieces embedded within the outer rim. Onto each resulting tooth is then wound the AC coils 8 of a synchronous motor which is electrically designed for phase count, current and voltage according to the particular application to which the wheel is targeted. An exciter body is then formed in a ring of magnetic material 9 which surrounds the armature body at a distance providing a gap 10 for magnetic separation and having at one side projecting fingers 11 which project around between even alternate teeth of the armature and in near magnetic contact with the pole pieces embedded in the rim. An exciter DC electrical coil 12 is then placed into an area provided. Coolant tubes 13 of compatible non-magnetic material such as stainless steel may then optionally be placed into the previously described gap 10, the remainder of which is filled to provide structural connection between the armature ring and the exciter body. The fill may be any castable material such as an epoxy, aluminum etc. A second part of the exciter body is formed of magnetic material into a mating ring 14 which can be bolted to the side of the main exciter ring with bolts 15 and also having at one side projecting fingers 16 which project around between odd alternate teeth of the armature and in near magnetic contact with the pole pieces embedded in the rim. A thin stiff non-magnetic sheet 17 is then bonded to the faces of the stator teeth, and carried around the body of the armature to provide environmental protection for the windings, and an electronics enclosure 21 to contain all or part of the electronics systems described in claims. The electronics enclosure 21 also would provide for heat sinks which participate in the cooling system provided for the motor windings, being one or more of local air cooling, remote ducted central air cooling, or remote conducted fluid cooling. Mounting provisions 18, 19 are made to support the stator on the same structure which supports the brake caliper not shown, which acts on brake disk 20.

If desired, brake disk 20 may be moved into the centre of the wheel by providing a gap of the required arc in the armature to fit the caliper, and designing the tooth count and pole piece count to suit the electrical requirement. The brake disk illustrated is 25 cm diameter, current standard for a typical sedan, and will fit within the armature shown if the tire mounts on a 40.5 cm diameter rim as shown, the tire having a section height to width ratio of 0.50, the width shown being 205 mm. These dimensions are given for illustration purposes only and are not to be taken as limitations on claims, just as it is apparent that other sizes may be implemented and many alternate configuration options of the motor as presented may be constructed without departing from the concepts stated in claims.

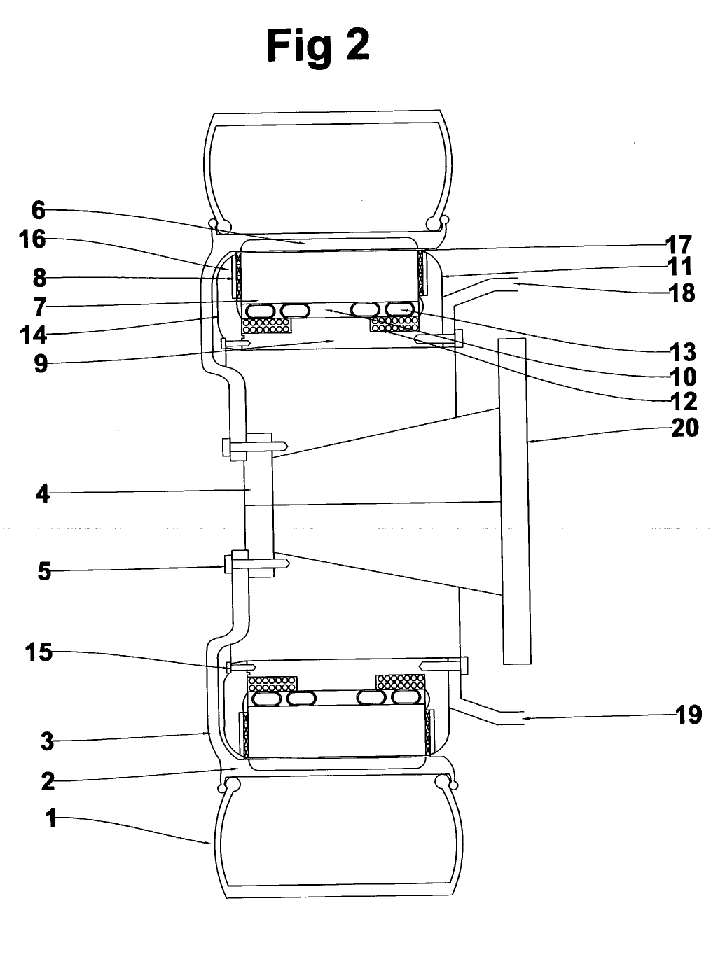

FIG. 2 is an axial section of the dynamo electric machine presented in FIG. 1.

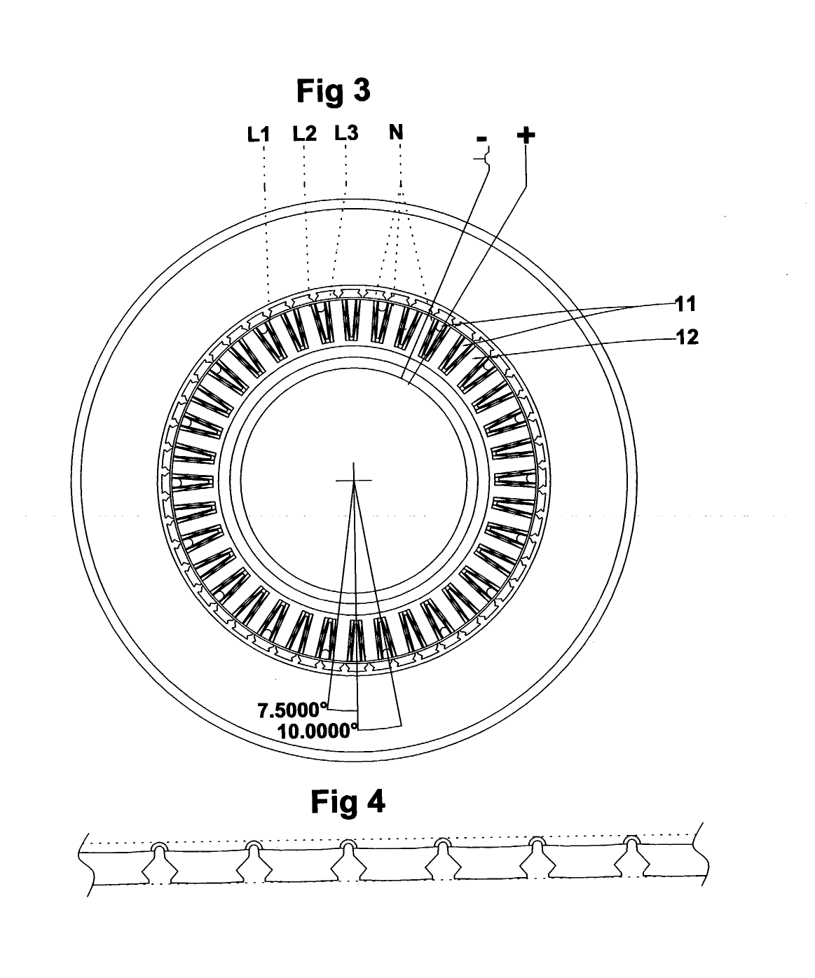

FIG. 3 is a cross section of the dynamo electric machine presented in FIG. 1. Illustrated is the detail of the exciter pole fingers 11 which extend alternately from the north magnetic side of the exciter body, then the south magnetic side, are interleaved between each stator armature tooth. Also apparent here is how the pole pieces are embedded into the rim, and the electrical details of the AC windings of this embodiment. A person skilled in the art can easily see from this view how the 36 AC windings of the 36 stator teeth may be connected to create a three phase winding which repeatedly alternates the exciter magnetic polarity of each tooth one complete cycle each 7.5 degrees of rotation of the rim, making it effectively a 48 pole motor or generator which will generate or require power at 960 hz at 1200 rpm, a frequency well within the comfort range of modern power electronics. If reasons are found to require diferent frequency, then the pole count can readily be increased or decreased, going as low as 4/3×phase count×2 at the minimum.

FIG. 4 is a plan view of one way the pole pieces of the wheel rim may be formed. A narrow, e.g.. 1 cm, strip of the laminating metal to become the pole pieces is punched in the pattern shown in FIG. 4. The strip is then wound tightly about a form having a core slightly smaller than the rim air gap, until the width of the pole pieces is accumulated. Additional forms are then installed to mould the balance of the wheel rim, and melted alluminum alloy is poured into the mould. Once the alloy has set, the half circular connecting tabs of the strip at the air gap are machined off in a lathe, leaving the desired pole pieces embedded into a finished face of the rim.

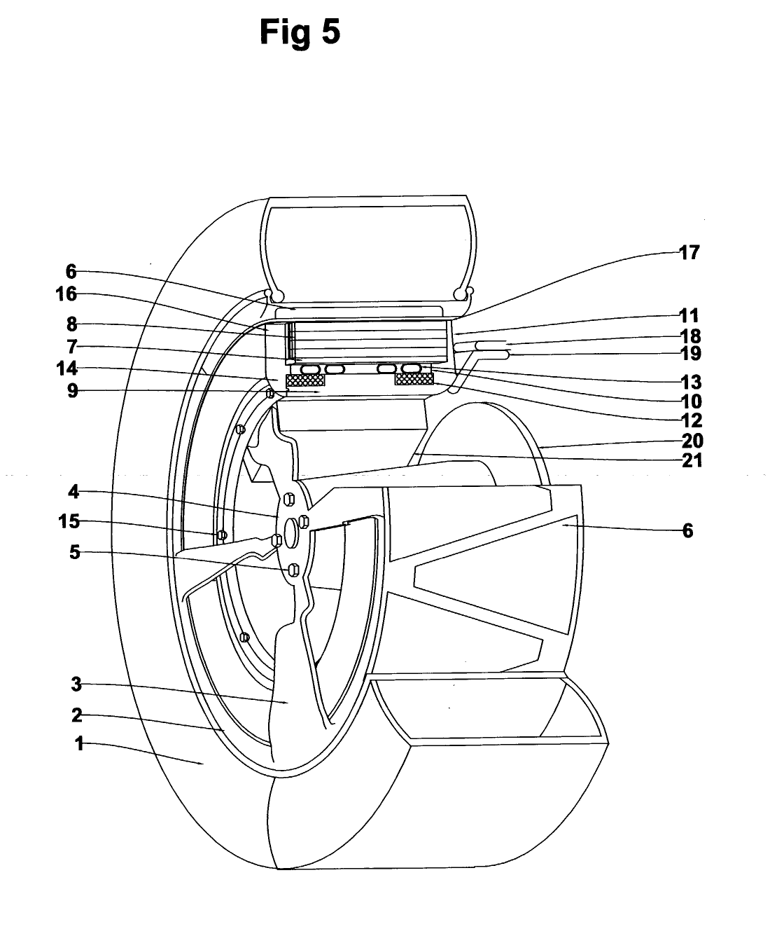

FIG. 5 is a perspective view partly cut away of a second preferred embodiment of the present invention. Illustrated is a wheel assembly consisting of a wheel comprised of a tire 1, a rim 2, and spokes 3 mounted on a hub 4 with lugnuts 5, the hub mounted on an axle by bearings not shown. Embedded into the rim with the faces exposed inward are solid magnetic pole pieces 6, the pieces separated from each other by a narrow strip of nonmagnetic material such as annealed stainless steel or aluminum alloy. A laminated magnetic core armature is then formed having a complete ring at the inner edge 7 with teeth projecting outward radially to approach very near the pole pieces embedded within the outer rim. Onto each resulting tooth is then wound the AC coils 8 of a synchronous motor which is electrically designed for phase count, current and voltage according to the particular application to which the wheel is targeted. An exciter body is then formed in a ring of magnetic material 9 which surrounds the armature body at a distance providing a gap 10 for magnetic separation and having at one side a projecting ring 11 which projects around the teeth of the armature and in near magnetic contact with the tips of alternate pole pieces embedded in the rim. An exciter DC electrical coil 12 is then placed into an area provided. Coolant tubes 13 of compatible non-magnetic material such as stainless steel may then optionally be placed into thermal contact with the stator body. A second part of the exciter body is formed of magnetic material into a mating ring 14 which can be bolted to the side of the main exciter ring with bolts 15 and also having a surface 16 which project toward and in near magnetic contact with the other alternate pole pieces embedded in the rim. A thin stiff non-magnetic sheet 17 is then bonded to the faces of the stator teeth, and carried around the body of the armature to provide environmental protection for the windings. Also provided is an electronics enclosure 21 to contain all or part of the electronics systems described in claims. The electronics enclosure 21 also would provide for heat sinks which participate in the cooling system provided for the motor windings, being one or more of local air cooling, remote ducted central air cooling, or remote conducted fluid cooling. Mounting provisions 18, 19 are made to support the stator on the same structure which supports the brake caliper and or suspension parts not shown. The brake caliper acts on brake disk 20.

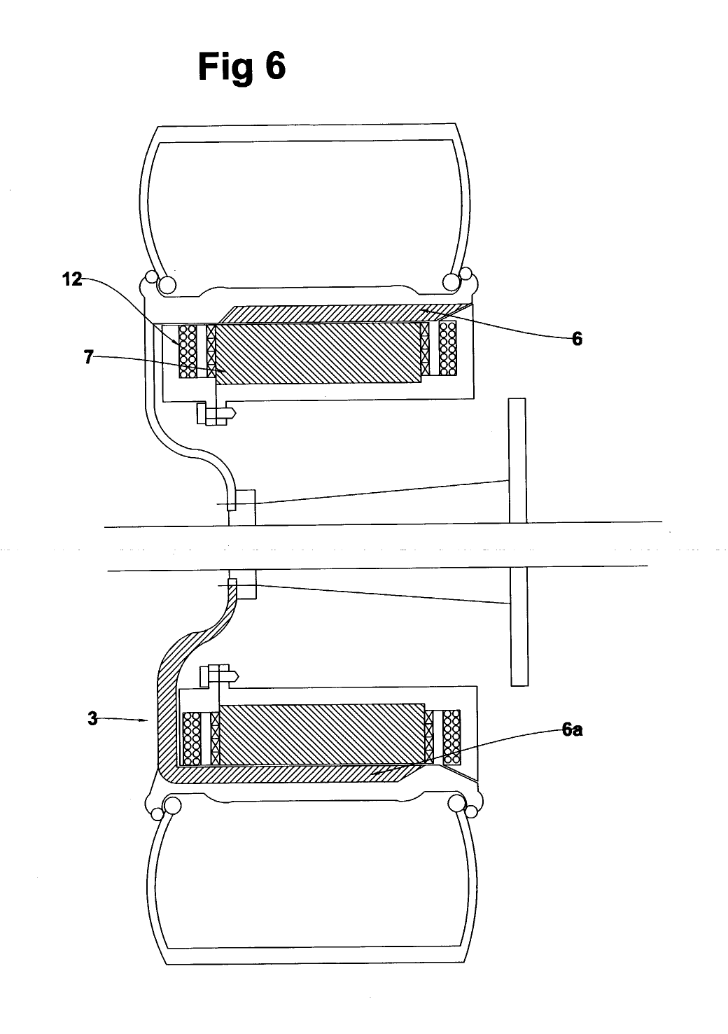

FIG. 6 is a section view detail along the axis of an embodiment similar to that in FIG. 5. In FIG. 6, exciter coils 12 are located at the side of the armature 7 rather than at the back, and the gap between the rotor and the stator at the back of the rim is relocated. The purpose of the move in this case is to increase the space within the stator to enable a standard sized brake disk to be installed within the wheel, thus moving the hinge point of a steered wheel nearer the centre of the tire. In this case an arc of the motor stator will be left blank to enable the brake caliper to be mounted in the gap. This illustrates only one alternative of many such re-configurations which may be made without altering the concept of the invention stated in claims. It can also be seen from this view that the alternate pole pieces 6a which connect magnetically with the exciter body at the side of the wheel having the spokes 3 could be fabricated as integral continuations of the spokes 3 thus contributing to the structural integrity of the wheel.

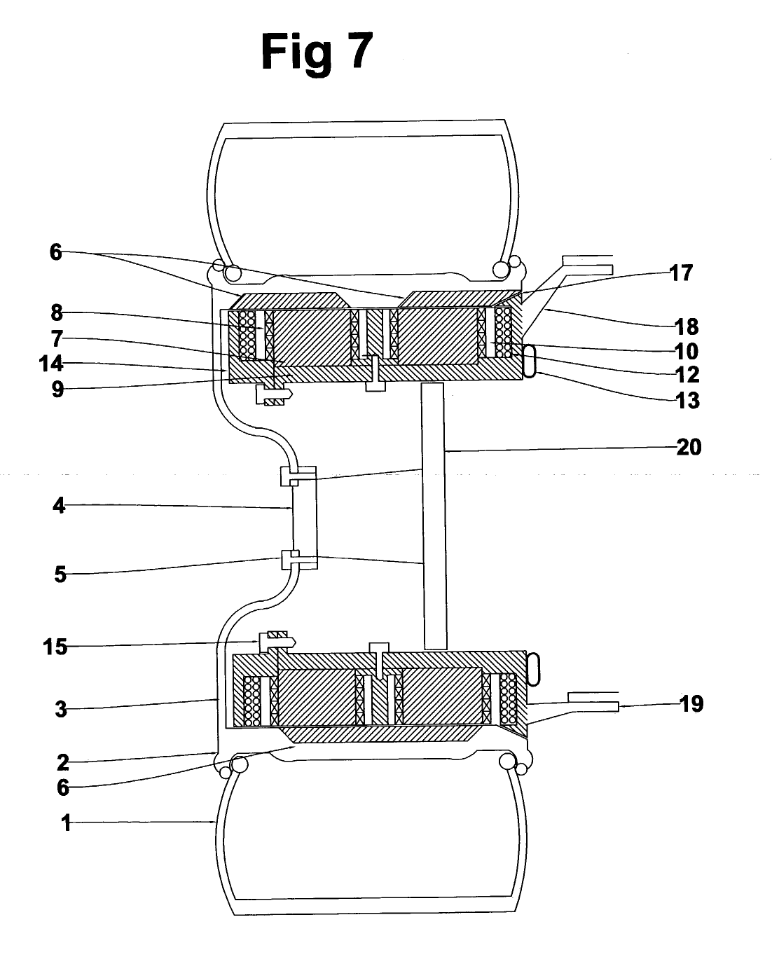

FIG. 7 is a section view along the axis of an alternate implementation of the second preferred embodiment of the present invention having multiple armatures mounted on the same axis and sharing exciter parts. All is the same as the explanation for FIG. 6 but for the splitting of the armature teeth into two rows which are separetely wound with the AC windings, and centre exciter ring 22 is added between the two rows of teeth to make magnetic contact with the centres of alternate pole pieces 6 embedded in the rim. In this instance the two exciter coils are connected to cause the two outer exciter rings to be of like polarity while the centre ring 22 is of opposite polarity. The purpose of this modification is to shorten the magnetic path in the exciter circuit, particularly the part of the path which proceeds through the pole pieces in the rim, since the depth of these is restricted by the space available. It can quickly be seen that there is no need to restrict the number of coaxial armatures installed in this manner to two since if need arises for a greater number then additional armatures may be implemented without departing from the invention as claimed.

FIG. 8 is a cross section view through the body of the dynamo electric machine of FIG. 5 or FIG. 7. A person skilled in motor winding design will see that the example showed can readily be connected for operation on 3 phase power at 6 cycles per rotation.

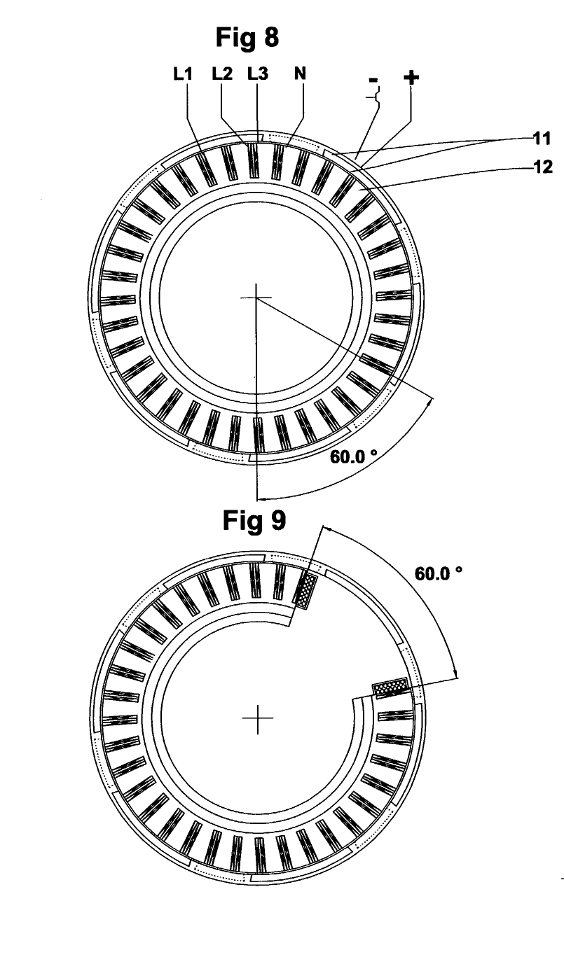

FIG. 9 is a cross section view through the body of the dynamo electric machine of FIG. 6, illustrating for this embodiment how an arc of stator may be left vacant for the mounting of a brake caliper not shown. The chosen arc of 60 degrees is for illustration purposes only, and does not limit the invention claimed to any specific arc. The design feature of leaving a vacant arc can also be applied to any of the other embodiments described.

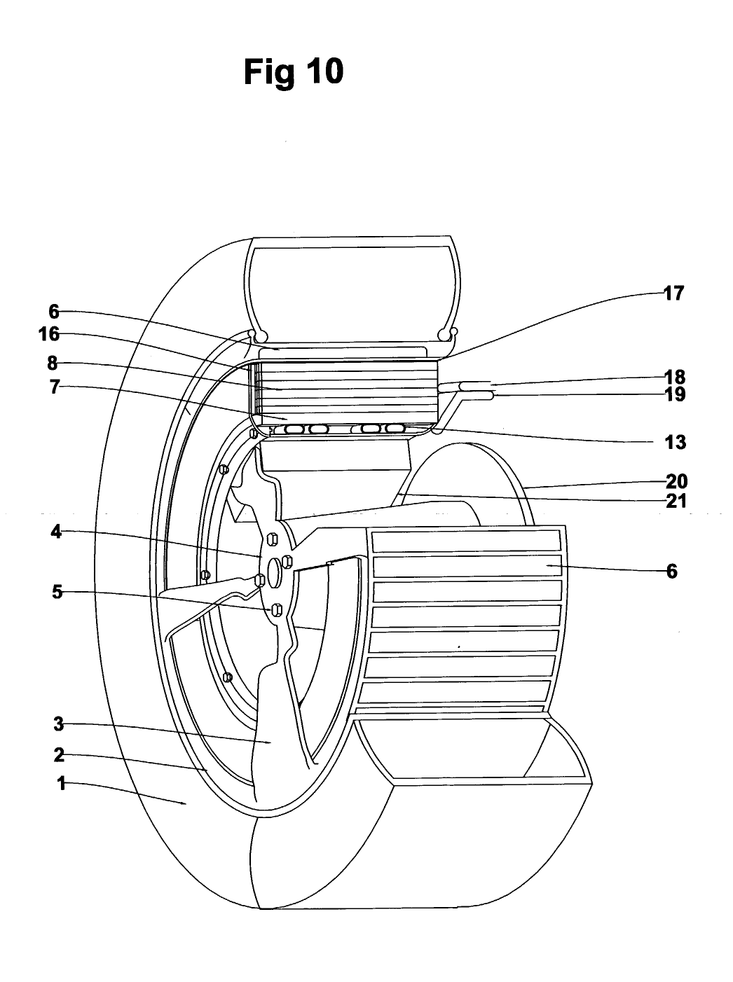

FIG. 10 is a perspective view partly cut away of a third preferred embodiment of the present invention. Illustrated is a wheel assembly consisting of a wheel comprised of a tire 1, a rim 2, and spokes 3 mounted on a hub 4 with lugnuts 5, the hub mounted on an axle by bearings not shown. Embedded into the rim with the faces exposed inward are solid magnetic pole pieces 6, the pieces separated from each other by a narrow strip of nonmagnetic material such as annealed stainless steel or aluminum alloy. A laminated magnetic core armature is then formed having a complete ring at the inner edge 7 with teeth projecting outward radially to approach very near the pole pieces embedded within the outer rim. Onto each alternate resulting tooth is then wound the AC coils 8 of a synchronous motor which is electrically designed for phase count, current and voltage according to the particular application to which the wheel is targeted. The DC exciter coils are then wound around the other alternate teeth of the armature. Coolant tubes 13 of compatible non-magnetic material such as stainless steel may then optionally be placed into thermal contact with the stator body. A thin stiff non-magnetic sheet 17 is then bonded to the faces of the stator teeth, and carried around the body of the armature to provide environmental protection for the windings. Also provided is an electronics enclosure 21 to contain all or part of the electronics systems described in claims. The electronics enclosure 21 also would provide for heat sinks which participate in the cooling system provided for the motor windings, being one or more of local air cooling, remote ducted central air cooling, or remote conducted fluid cooling. Mounting provisions 18, 19 are made to support the stator on the same structure which supports the brake caliper and or suspension parts not shown. The brake caliper acts on brake disk 20.

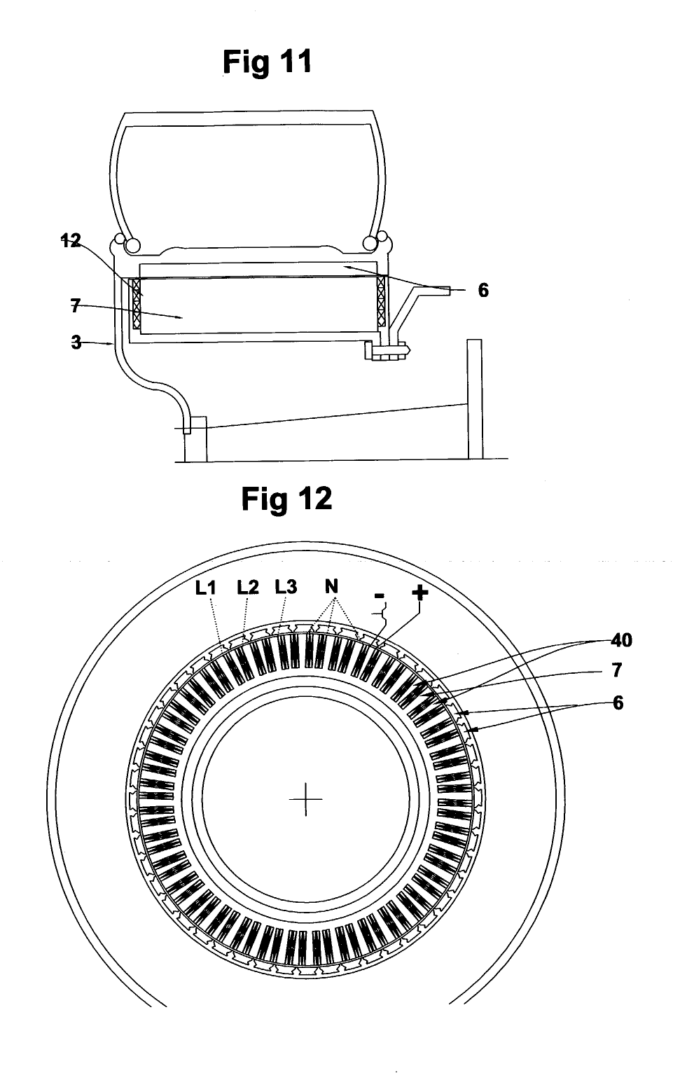

FIG. 11 is a section view along the axis of the top half of FIG. 10, the bottom half being basically identical. Illustrated in particular is the armature teeth 7 surrounded by winding 12. In this embodiment, each second tooth of the armature circumferentially, starting with a narrower tooth, is wound with the DC exciter winding in alternate directions so that the projecting faces of alternate exciter teeth around the armature are continuously magnetized alternately North then South magnetic poles. The AC winding is then installed in the standard manner on each alternate and slightly wider armature tooth.

FIG. 12 is a cross section view through the body of the dynamo electric machine of FIG. 11. illustrated is the detail of the exciter pole teeth 40 which extend alternately from among and are interleaved between each stator armature tooth 8. Also apparent here is how the pole pieces 6 are embedded into the rim, and the electrical details of the AC windings of this embodiment. A person skilled in the art can easily see from this view how the 36 AC windings of the 36 alternate stator teeth may be connected to create a three phase winding which repeatedly alternates the exciter magnetic polarity of each tooth one complete cycle each 7.5 degrees of rotation of the rim, making it effectively a 48 pole motor or generator which will generate or require power at 960 hz at 1200 rpm, a frequency well within the comfort range of modern power electronics. If reasons are found to require diferent frequency, then the pole count can readily be increased or decreased, going as low as 4/3×phase count×2 at the minimum.

I claim:

1. A dynamo electric machine comprising
a) a stator constructed by
i) linking the peripheral portions which are disposed nearest to the axis of a plurality of armature teeth arranged at equiangular pitches in a circumferential direction
by an annular core body, and winding around the teeth a plurality of coils composed entirely of coils that are excited by alternating current; and
ii) installing an exciter pole member comprised of
1. a circumferential band of either inherently magnetized material or of easily electrically magnetizable material disposed further toward the axis of the annular core at an intervening distance to provide magnetic separation therefrom
2. a plurality of teeth equal in number to the armature teeth and projecting alternately from opposite sides of the circumferential band, the teeth shaped so that each one projects outward, then between the armature teeth alternately from one side, then from the other side
3. a field coil wound in bobbin fashion proximate to the circumferential band of magnetic material in a manner that a direct current flowing in the coil will cause the teeth projecting from one side of the band to become magnetized as north magnetic poles, and the teeth projecting from the other side of the band to become magnetized as south magnetic poles.
b) a wheel constructed by
i) molding, forging, machining or otherwise shaping a non-magnetic material into the shape of a rim designed to mount a standard tire
ii) embedding a plurality of magnetic poles composed of magnetic members arranged at equiangular pitches in the circumferential direction, into the central base portion of the wheel rim, the magnetic poles being formed into one piece by the base portion
iii) connecting the resulting rim to a central hub by spokes or other means, the hub being rotatably disposed centrally on an axle disposed on an axis of the stator, and the pole pieces which are embedded in the base portion of the rim being disposed adjacently to an outer periphery of the stator
c) a wheel assembly constructed by connecting the axle of the central hub to the stator by spokes or other means which maintain a fixed gap between the stator and the pole pieces which are embedded in the base portion of the wheel rim.

2. A dynamo-electric machine according to claim 1, wherein a ratio of a number of the teeth on the stator and a number of the magnetic poles installed into the rim is [phase count]/[phase count+1].

3. A dynamo-electric machine according to claim 2, wherein a part of the circumference of the stator is left vacant of magnetic material and windings to
a) facilitate the installation of a mechanical brake caliper which interacts with a rotor disk connected to the said central hub and/or.
b) provide for drainage of water from the gap between the stator and the wheel and/or
c) provide for a remaining part of the circumference to be occupied by another motor stator of different electrical, magnetic or mechanical characteristics and/or.
d) other purposes which may occur to a designer and a ratio of a number of the teeth on the stator and a number of the magnetic poles installed into the rim is [phase count]/[phase count+1]×[angular arc of stator]/360.

4. A dynamo-electric machine according to claim 2, wherein an enclosure composed entirely or in part of non-magnetic material is disposed to partly or hermetically seal the stator from the environment.

5. A dynamo-electric machine according to claim 2, wherein an enclosure is integrally provided near to the stator, containing electronic circuits capable of
a) accepting and permanently storing, on initial installation, assignment as being mounted on either the left or right side of a vehicle.
b) accepting, interpreting and replaceably storing a digital signal on a serial communication link which is encoded with demand rate of speed, direction and demand rate of acceleration or deceleration data
c) modifying DC current supplied externally into a DC voltage and current sufficient to adequately energize the exciter circuit of the said dynamo-electric machine based on the stored demand rates, and applying the DC current to the exciter
d) converting a DC current supplied externally into an AC waveform of correct amplitude and frequency that when it is applied to the stator AC windings the rim is caused to rotate at a rate and direction according to the stored demand rates.
e) implementing locally using sensors installed within the wheel assembly or in cooperation with additional signal data supplied as at b), a method of automated dynamic braking with the goal of maximizing braking force or generated power while maintaining effective rolling contact between the tire and the road surface.
f) monitoring the condition of the stator and the exciter for temperature, insulation resistance, winding resistance or other conditions, converting the results into a digital signal and communication the signal back along the serial communication link for operator warning, maintenance or repair purposes.

6. A dynamo-electric machine according to claim 5, wherein an actuator capable of operating the disk brake caliper is also installed locally on the assembly and the actuator is operated by the same control logic which implements dynamic braking in the motor.

7. A dynamo electric machine comprising
a) a stator constructed by
i) linking the peripheral portions which are disposed nearest to the axis of a plurality of armature teeth arranged at equiangular pitches in a circumferential direction
by an annular core body, and winding around the teeth a plurality of coils composed entirely of coils that are excited by alternating current; and
ii) installing an exciter pole member comprised of
1. a circumferential band of either inherently magnetized material or of easily electrically magnetizable material disposed further toward the axis of the annular core at an intervening distance to provide magnetic separation therefrom
2. a pair of rings projecting alternately from opposite sides of the circumferential band, the rings shaped so that each one projects outward along the armature teeth alternately from one side, then from the other side
3. a field coil wound in bobbin fashion proximate to the circumferential band of magnetic material in a manner that a direct current flowing in the coil will cause the ring projecting from one side of the band to become magnetized as a north magnetic pole, and the ring projecting from the other side of the band to become magnetized as a south magnetic pole.
b) a wheel constructed by
i) molding, forging, machining or otherwise shaping a non-magnetic material into the shape of a rim designed to mount a standard tire
ii) embedding a plurality of magnetic poles composed of magnetic members arranged at equiangular pitches in the circumferential direction, into the central base portion of the wheel rim, the magnetic poles being formed into one piece by the base portion, and alternate pole pieces projecting further first to one side, then the other side of the rim.
iii) connecting the resulting rim to a central hub by spokes or other means, the hub being rotatably disposed centrally on an axle disposed on an axis of the stator, and the pole pieces which are embedded in the base portion of the rim being disposed adjacently to an outer periphery of the stator
c) a wheel assembly constructed by connecting the axle of the central hub to the stator by spokes or other means which maintain a fixed gap between the stator and the pole pieces which are embedded in the base portion of the wheel rim.

8. A dynamo-electric machine according to claim 7, wherein the ratio of the number of the teeth on the stator armature and the number of the magnetic poles installed into the rim is equal to the [phase count].

9. A dynamo-electric machine according to claim 8, wherein a part of the circumference of the stator is left vacant of magnetic material and windings to
a) facilitate the installation of a mechanical brake caliper which interacts with a rotor disk connected to the said central hub and/or.
b) provide for drainage of water from the gap between the stator and the wheel and/or
c) provide for a remaining part of the circumference to be occupied by another motor stator of different electrical, magnetic or mechanical characteristics and/or.
d) any other purposes and the ratio of the number of the teeth on the stator armature and the number of the magnetic poles installed into the rim is equal to the [phase count]×[angular arc of stator]/360.

10. A dynamo-electric machine according to claim 8, wherein an enclosure composed entirely or in part of non-magnetic material is disposed to partially or hermetically seal the stator from the environment.

11. A dynamo-electric machine according to claim 8, wherein an enclosure is integrally provided near to the stator, containing electronic circuits capable of
a) accepting and permanently storing, on initial installation, assignment as being mounted on either the left or right side of a vehicle.
b) accepting, interpreting and replaceably storing a digital signal on a serial communication link which is encoded with demand rate of speed, direction and demand rate of acceleration or deceleration data
c) modifying DC current supplied externally into a DC voltage and current sufficient to adequately energize the exciter circuit of the said dynamo-electric machine based on the stored demand rates, and applying the DC current to the exciter
d) converting a DC current supplied externally into an AC waveform of correct amplitude and frequency that when it is applied to the stator AC windings the rim is caused to rotate at a rate and direction according to the stored demand rates.
e) implementing locally using sensors installed within the wheel assembly or in cooperation with additional signal data supplied as at b), a method of automated dynamic braking with the goal of maximizing braking force or generated power while maintaining effective rolling contact between the tire and the road surface.
f) monitoring the condition of the stator and the exciter for temperature, insulation resistance, winding resistance or other conditions, converting the results into a digital signal and communication the signal back along the serial communication link for operator warning, maintenance or repair purposes.

12. A dynamo-electric machine according to claim 11, wherein an actuator capable of operating the disk brake caliper is also installed locally on the assembly and the actuator is operated by the same control logic which implements dynamic braking in the motor.

13. A dynamo-electric machine according to claim 8, wherein the machine is comprised of two or more armatures and AC windings constructed according to claim 8 and installed adjacent axially and sharing exciter rings and rotor pole pieces as may be possible.

14. A dynamo-electric machine according to claim 13, wherein a part of the circumference of the stator is left vacant of magnetic material and windings to
a) facilitate the installation of a mechanical brake caliper which interacts with a rotor disk connected to the said central hub and/or.
b) provide for drainage of water from the gap between the stator and the wheel and/or
c) provide for a remaining part of the circumference to be occupied by another motor stator of different electrical, magnetic or mechanical characteristics and/or.
d) other purposes which may occur to a designer and wherein the ratio of the number of the teeth on the stator armature and the number of the magnetic poles installed into the rim is equal to the [phase count]×[angular arc of stator]/360.

15. A dynamo-electric machine according to claim 13, wherein an enclosure composed entirely or in part of non-magnetic material is disposed to partially or hermetically seal the stator from the environment.

16. A dynamo-electric machine according to claim 13, wherein an enclosure is integrally provided near to the stator, containing electronic circuits capable of
a) accepting and permanently storing, on initial installation, assignment as being mounted on either the left or right side of a vehicle.
b) accepting, interpreting and replaceably storing a digital signal on a serial communication link which is encoded with demand rate of speed, direction and demand rate of acceleration or deceleration data
c) modifying DC current supplied externally into a DC voltage and current sufficient to adequately energize the exciter circuit of the said dynamo-electric machine based on the stored demand rates, and applying the DC current to the exciter
d) converting a DC current supplied externally into an AC waveform of correct amplitude and frequency that when it is applied to the stator AC windings the rim is caused to rotate at a rate and direction according to the stored demand rates.
e) implementing locally using sensors installed within the wheel assembly or in cooperation with additional signal data supplied as at b), a method of automated dynamic braking with the goal of maximizing braking force or generated power while maintaining effective rolling contact between the tire and the road surface.
f) monitoring the condition of the stator and the exciter for temperature, insulation resistance, winding resistance or other conditions, converting the results into a digital signal and communication the signal back along the serial communication link for operator warning, maintenance or repair purposes.

17. A dynamo-electric machine according to claim 16, wherein an actuator capable of operating the disk brake caliper is also installed locally on the assembly and the actuator is operated by the same control logic which implements dynamic braking in the motor.

18. A dynamo electric machine comprising
a) a stator constructed by
i) linking the peripheral portions which are disposed nearest to the axis of a plurality of armature teeth arranged at equiangular pitches in a circumferential direction
by an annular core body,
and winding around the teeth a plurality of coils composed partly of coils that are excited by alternating current and partly of coils that are excited by direct current; and
b) a wheel constructed by
i) molding, forging, machining or otherwise shaping a non-magnetic material into the shape of a rim designed to mount a standard tire
ii) embedding a plurality of magnetic poles composed of magnetic members arranged at equiangular pitches in the circumferential direction, into the central base portion of the wheel rim, the magnetic poles being formed into one piece by the base portion
iii) connecting the resulting rim to a central hub by spokes or other means, the hub being rotatably disposed centrally on an axle disposed on an axis of the stator, and the pole pieces which are embedded in the base portion of the rim being disposed adjacently to an outer periphery of the stator
c) a wheel assembly constructed by connecting the axle of the central hub to the stator by spokes or other means which maintain a fixed gap between the stator and the pole pieces which are embedded in the base portion of the wheel rim.

19. A dynamo-electric machine according to claim 18, wherein a ratio of a number of the teeth on the stator and a number of the magnetic poles installed into the rim is [2×phase count]/[phase count+1 ].

20. A dynamo-electric machine according to claim 19, wherein a part of the circumference of the stator is left vacant of magnetic material and windings to
a) facilitate the installation of a mechanical brake caliper which interacts with a rotor disk connected to the said central hub.
b) provide for drainage of water from the gap between the stator and the wheel
c) provide for a remaining part of the circumference to be occupied by another motor stator of different electrical, magnetic or mechanical characteristics.
d) other purposes which may occur to a designer and wherein a ratio of a number of the teeth on the stator and a number of the magnetic poles installed into the rim is [2×phase count]/[phase count+1]×[stator angular arc]/360.

21. A dynamo-electric machine according to claim 19, wherein an enclosure composed entirely or in part of non-magnetic material is disposed to seal the stator hermetically from the environment.

22. A dynamo-electric machine according to claim 19, wherein an enclosure is integrally provided near to the stator, containing electronic circuits capable of
a) accepting and permanently storing, on initial installation, assignment as being mounted on either the left or right side of a vehicle.
b) accepting, interpreting and replaceably storing a digital signal on a serial communication link which is encoded with demand rate of speed, direction and demand rate of acceleration or deceleration data
c) modifying DC current supplied externally into a DC voltage and current sufficient to adequately energize the exciter circuit of the said dynamo-electric machine based on the stored demand rates, and applying the DC current to the exciter
d) converting a DC current supplied externally into an AC waveform of correct amplitude and frequency that when it is applied to the stator AC windings the rim is caused to rotate at a rate and direction according to the stored demand rates.
e) implementing locally using sensors installed within the wheel assembly or in cooperation with additional signal data supplied as at b), a method of automated dynamic braking with the goal of maximizing braking force or generated power while maintaining effective rolling contact between the tire and the road surface.
f) monitoring the condition of the stator and the exciter for temperature, insulation resistance, winding resistance or other conditions, converting the results into a digital signal and communication the signal back along the serial communication link for operator warning, maintenance or repair purposes.

23. A dynamo-electric machine according to claim 22, wherein an actuator capable of operating the disk brake caliper is also installed locally on the assembly and the actuator is operated by the same control logic which implements dynamic braking in the motor.
